(19) United States
(12) Patent Application Publication
(10) Pub. No.: US 2017/0116584 A1
(43) Pub. Date: Apr. 27, 2017

(54) Systems and Methods for Identifying Payment Accounts to Segments

(71) Applicant: MASTERCARD INTERNATIONAL INCORPORATED, Purchase, NY (US)

(72) Inventors: Jason Jay Lacoss-Arnold, St. Louis, MO (US); Jason M. Mueller, O'Fallon, MO (US); Jeffrey L. Altemueller, Marthasville, MO (US); Krista Tedder, O'Fallon, MO (US)

(21) Appl. No.: 14/918,981

(22) Filed: Oct. 21, 2015

(51) Int. Cl. G06Q 20/10; G06F 21/57; G06F 21/55

(52) U.S. Cl. CPC G06Q 20/10; G06F 21/55; G06F 21/577

(57) ABSTRACT

Systems and methods for use in segmenting payment accounts based on threat events are disclosed. An exemplary method includes identifying, by a computing device, a payment account associated with a threat event, appending, by the computing device, the payment account to a risk segment, and causing review of the payment account based on inclusion of the payment account in said risk segment. The threat event may include a contact by a risk associated computing device accessing the payment account, or a contact by a risk associated user accessing the payment account.

### FIELD

The present disclosure generally relates to systems and methods for identifying payment accounts to segments based on threat events and, in particular, to identifying threat events associated with the payment accounts and then appending the payment accounts to risk segments based on the threat events.

### BACKGROUND

This section provides background information related to the present disclosure which is not necessarily prior art.

Payment accounts are used by consumers to perform numerous different transactions including, for example, purchasing products such as goods and/or services from merchants, etc. Through use of the payment accounts, or through the consumers' handling of payment devices for the payment accounts and/or access credentials associated with the payment accounts, unauthorized users may gain access to the payment accounts and attempt to use the payment accounts to fund transactions without permission or knowledge of the consumers. Such unauthorized access may be gained in different manners, for example, through nefarious software at computing devices used by the consumers, or by other entities, to access the payment accounts, whereby the nefarious software permits the unauthorized users to directly access the payment accounts and/or control the computing devices to gain such access.

### DRAWINGS

The drawings described herein are for illustrative purposes only of selected embodiments and not all possible implementations, and are not intended to limit the scope of the present disclosure.

FIG. 1 shows an exemplary system for identifying payment accounts to segments based on threat events, and including one or more aspects of the present disclosure;

FIG. 2 is a block diagram of an exemplary computing device, suitable for use in the system of FIG. 1; and

FIG. 3 is a flowchart of an exemplary method of identifying payment accounts to segments based on threat events, which can be implemented via the system of FIG. 1.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Unauthorized users often attempt to gain (and often do gain) access to payment accounts without permission from consumers (i.e., owners) associated with the payment accounts. Such access provides opportunity for the unauthorized users to use the payment accounts without permission from the consumers, or to access other information about the payment accounts and/or consumers. The systems and methods herein identify threat events for payment accounts, such as access by unauthorized users, based on contact with the payment accounts by risk associated computing devices and/or by risk associated users. The threat events are indicative of threats to the payment accounts, etc. In response to the threat events, the systems and methods herein append the payment accounts to one or more risk segments, and then cause reviews of the payment accounts to determine if actual threats are present. This may include notifying issuers of the payment accounts who, in response, then place one or more restrictions on the access to and/or usage of the payment accounts until the potential threats are resolved and the payment accounts are verified through the reviews. In this manner, identifying the payment accounts to risk segments, based on the threat events, helps inhibit unauthorized access to and/or usage of the payment accounts.

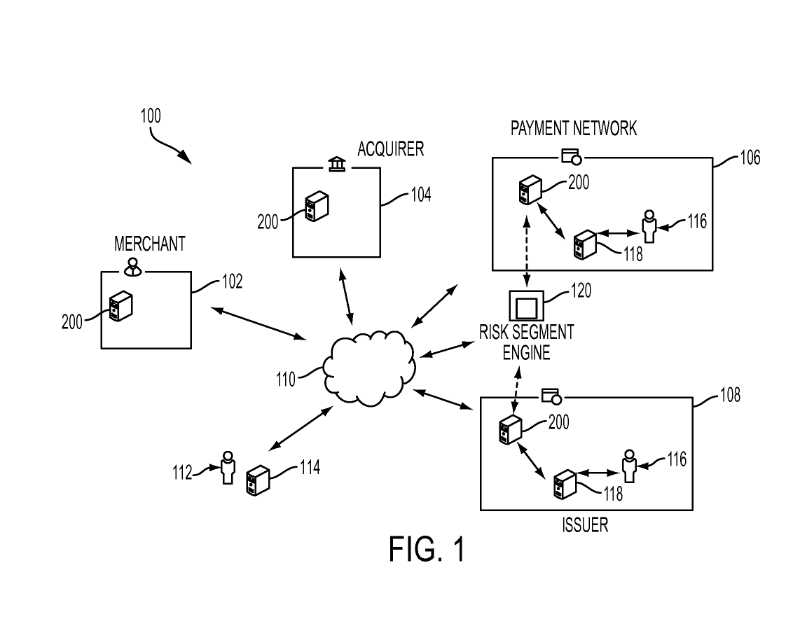

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, for example, depending on processing of payment transactions, communication between issuers and payment networks, etc.

As shown in FIG. 1, the illustrated system 100 generally includes a merchant 102, an acquirer 104, a payment network 106, and an issuer 108, each coupled to (and in communication with) a network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular in this example, the acquirer 104, the payment network 106, and the issuer 108 may be connected via a private network that is part of network 110 for processing payment transactions, and the merchant 102 and consumer 112 may be connected through a public network, such as the Internet, that is also part of network 110.

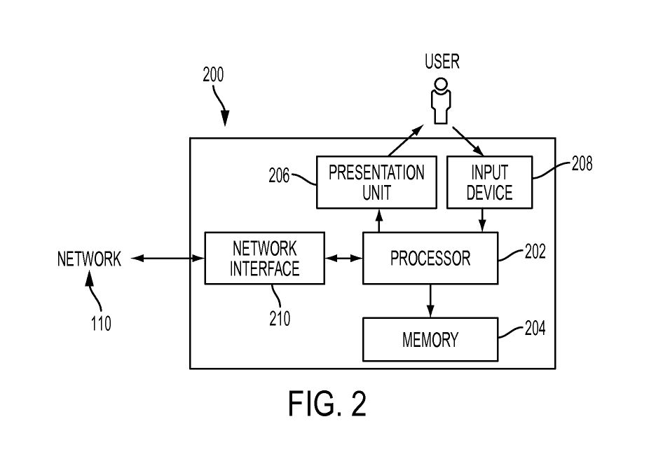

FIG. 2 illustrates an exemplary computing device 200 that can be used in the system 100. The computing device 200 may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchant 102, the acquirer 104, the payment network 106, and the issuer 108 are illustrated as including, or being implemented in, computing device 200, coupled to (and in communication with) the network 110. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, data relating to payment accounts, transaction data for transactions processed to the payment accounts, risk segments, account activity violations, data relating to nefarious software detection, click patterns, rules and/or restrictions on payment accounts, and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to (and in communication with) the processor 202 (however, it should be appreciated that the computing device 200 could include output devices other than the presentation unit 206, etc.). The presentation unit 206 outputs information, either visually or audibly to a user of the computing device 200, for example, the consumer 112 in the system 100, one or more of users 116 in the system 100, etc. It should be further appreciated that various interfaces (e.g., application interfaces, webpages, etc.) may be displayed at computing device 200, and in particular at presentation unit 206, to display information, such as, for example, information relating to payment accounts, payment accounts appended to risk segments, rules and/or restrictions on payment accounts, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs) such as, for example, clicks at links of web interfaces, etc. The input device 208 is coupled to (and in communication with) the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 includes the consumer 112, who is associated with computing device 114, which, in this embodiment, is consistent with computing device 200. The computing device 114, as indicated above, may include, for example, a smartphone, tablet, a workstation, or other suitable device for use with, or that is capable of providing access to a payment account associated with the consumer 112 (and issued by the issuer 108) such as, for example, via one or more web-based interfaces (e.g., applications, websites, portals, etc.) and through network 110.

In one example, the consumer 112 may access his/her payment account, via computing device 114, through a web-based interface associated with the payment network 106 or issuer 108, to view balance details, to change account settings (e.g., address, contact information, preferences, etc.), or to make payments, etc. Often, when the consumer 112 (or another person/entity acting as the consumer 112) accesses and/or utilizes the web-based interface, he/she often clicks different links within an interface (generally at a particular rate or interval, etc.) to perform desired functions as described above, for example, and/or other functions. The different links included in the web-based interface are typically designated or identified sequentially. As such, when the consumer 112 accesses and/or utilizes the interface, the consumer's use of inputs to the interface, via the computing device 114, will usually be out of sequence because selecting the links in sequence, i.e., an ordered click-through of the different links, will not perform any of the desired functions typically performed at the interface, for example, by the consumer 112. Conversely, an ordered click-through (broadly, a click pattern) of the different links in the interface is generally indicative of an automated entity accessing the web interface. Similarly, a temporal based click-through (broadly, a click pattern) of the different links (in any order) at a rate faster than a human can typically perform or at repeated intervals comprising routine, predicable times is generally indicative of an automated entity accessing the web interface.

It should be appreciated that the consumer 112, via computing device 114, may have a variety of different interactions with the issuer 108, or the payment network 106, at different web-based interfaces associated therewith. Through such interactions, the consumer 112 may click various different links at the different interfaces, indicative of typical use by the consumer 112. However, particular click patterns may be recognized at one or more of the different interfaces (e.g., ordered click-through patterns, etc.) that may be indicative of atypical use, and a possible threat associated therewith. In various embodiments, such click patterns at the different interfaces may be determined to be a threat event (or used to determine that a threat event exists).

Further in the system 100, the payment network 106 and the issuer 108 may employ users 116 to provide consumer assistance, i.e., as customer service personnel, etc. Each user 116 is associated with a computing device 118, which is consistent with computing device 200. In general, the users 116 will interact with the consumer 112 (and other consumers in the system 100), and further utilize the computing device 118 to access the consumer's payment account to offer assistance with issues encountered by the consumer 112 or to answer related questions, or to provide additional service offers, or perform other functions related to the consumer's payment account, etc. While the users 116, and their associated computing devices 118, are illustrated as included in both the payment network 106 and the issuer 108, in other embodiments only the payment network 106 or only the issuer 108 may include such users. Further, in other embodiments, the acquirer 104 and/or the merchant 102 may include such users. Consistent with the description below, it should be appreciated that any entity, which may access a payment account, via one or more different means, may include or may be implemented in a computing device, such as computing device 114 or 118 in system 100 and, thus, may be subject to the methods described below.

The users 116, as indicated above, typically access the payment account of the consumer 112 in response to requests for service from the consumer 112, or in connection with one or more other factors (e.g., routine payment account maintenance, fraud alerts, charge disputes, and/or any other instances that might require access to the consumer's payment account, etc.). When either of the users 116, in the system 100, accesses the consumer's payment account, information associated with the payment account is available to their computing device 118. Likewise, when consumer 112 accesses his/her payment account via computing device 114, access to information associated with the payment account is available to the computing device 114.

If any of the computing devices 114 or 118 associated with the consumer 112 or the users 116, which is accessing the payment account information, is infected or otherwise exposed or accessible to nefarious software (e.g., malware, viruses, Trojans, etc.), the payment account information may also be accessible to the nefarious software. In some instances, the nefarious software permits unauthorized entities to access and/or control the computing devices 114 and 118, or provides access to credentials entered in the computing devices 114 and 118 (e.g., where the consumer 112 and/or users 116 are tricked to enter their credentials into nefarious sites controlled by the unauthorized entities via phishing, pharming, etc.).

The computing devices 118, and the payment network 106 and/or issuer 108 more generally with which the computing devices 118 are associated, typically include one or multiple different defense mechanisms against various different types of nefarious software. Such defense mechanisms may be at a user level (e.g., user training, etc.), at a computing device level (e.g., anti-virus and anti-malware software, etc.), at a system level (e.g., system controls and hardening, etc.), and/or at a network level (e.g., firewalls, etc.), etc. As the nefarious software is detected, it is removed from the payment network 106 and/or issuer 108 (and associated computing devices 118), or otherwise remedied and/or quarantined to ensure the nefarious software is removed and its access to other computing devices is limited or eliminated. The consumer 112 may or may not have similar defense mechanisms in place, at computing device 114. As indicated below, the detection of such software, at any of the computing devices 114 and 118, may be determined to be a threat event.

Apart from nefarious software, the users 116 may, in certain circumstances, depart from standard procedures when interacting with the consumer 112, or someone posing to be the consumer 112, i.e., a fraudulent consumer. In such instances, the interactions between the users 116 and the consumer 112 (whether actual or fraudulent) may generate an account activity violation. Specifically, for example, when one of the users 116 permits a consumer to change an address associated with a payment account, and then receives a request for a replacement payment device (e.g., a replacement credit or debit card, etc.), it is possible the consumer is actually a fraudulent consumer pretending to be the consumer 112 to cause the payment device to be delivered to a location at which the fraudulent consumer would be able to retrieve it (for use in performing fraudulent transactions). Standard procedures typically direct the users 116 against issuing the replacement device in such instances. However, if the user 116 permits the replacement payment device to be ordered and delivered, notwithstanding the recent address change, the user 116 may be in violation of the standard procedures, and the user's action, with regard to the payment account and other payment accounts is considered an account activity violation. It should be appreciated that a variety of different activities and/or patterns may give rise to an account activity violation, whereby the user 116, at payment network 106 and/or at issuer 108, violates a standard procedure and, as a result, initiates or causes a risk of fraud. As indicated below, these account activity violations may be determined to be threat events.

In addition, the issuer 108 may identify different types of transactions as normal or abnormal based on a type of payment account used in the transactions. Specifically, for example, a prepaid payment account may include a travel card, for which certain transactions will be identified as abnormal. In so doing, the issuer 108 may rely on different aspects of the transactions to determine which individual transactions are abnormal. For example, the issuer 108 may identify a transaction for appliance repairs to be abnormal when involving a prepaid travel card. Or, the issuer 108 may identify a transaction made in the U.S., in dollars, using a prepaid travel card (or any transaction made in the U.S. using the prepaid travel card) as abnormal when the prepaid travel card is denominated in pounds (e.g., a transaction involving the purchase of groceries in the U.S. with a British pound denominated travel card, etc.). It should be appreciated that the criteria may be different for other types of payment accounts, or different for the same types of payment accounts (payroll card verses travel card, general purpose reloadable (GPR) payment device, non-reloadable gift card, etc.). As indicated below, these types of abnormal transactions may be determined to be threat events (such that, when identified, the associated payment accounts may be assigned, or appended, to particular risk segments for additional monitoring and/or investigation, as will be described more hereinafter).

With continued reference to FIG. 1, the system 100 further includes a risk segment engine 120, which is specifically configured, often by executable instructions, to cause a processor, for example, to perform multiple operations as described herein. The engine 120 may be a standalone computing device consistent with computing device 200 (as illustrated in FIG. 1), or it may be incorporated in or with the payment network 106 or the issuer 108 (e.g., in the issuer's computing device 200, in the payment network's computing device 200, etc.) (as generally indicated by the dotted lines in FIG. 1). Further still, it should be appreciated that the engine 120 may be included in part, or in whole, in other parts of the system 100, including, for example, the acquirer 104 (e.g., where the engine 120 could be used to help protect merchants, etc.), etc.

The engine 120 is generally configured to append payment accounts to segments, such as risk segments, based on threat events associated with the payment accounts.

In particular, the engine 120 is configured to identify a payment account associated with a threat event. Identifying the payment account may, in some embodiments, include receiving the threat event, or a notification thereof, from the issuer 108 and/or the acquirer 104, for example. In at least one embodiment, the threat event is detected by the engine 120, and then the payment account is identified therefrom. As described above, the threat event, for example, may include a contact with the payment account by a risk associated computing device, or a contact with the payment account by a risk associated user. A contact by a risk associated computing device may include, for example, particular click patterns such as an ordered click-through to an interface of a website providing access to the payment account, etc. In addition, a contact by a risk associated computing device may include, for example, access to the payment account by one of computing devices 118 when infected by nefarious software (i.e., risk associated access), or access by one of the users 116 when involved in an account activity violation (i.e., risk associated access). A further threat event may include, as described above, a detection of an abnormal transaction to a particular type of payment account.

In any case, when the payment account is identified, based on the particular threat event(s), the engine 120 is configured to append the payment account to a risk segment, or to multiple risk segments. Different risk segments may be used for different levels of threat events, where each of the risk segments may then include different countermeasures for addressing the threat events, for different payment account types, etc. For example, payment accounts experiencing lower level threat events may be appended to low-risk segments where (in response) the payment accounts are transmitted for real time fraud scoring and/or monitoring of subsequent transactions, or where limitations or restrictions relating to merchant categories, transaction amounts, cross-border usage, internet transactions, etc. are implemented. Payment accounts experiencing medium level threat events may be appended to medium-risk segments where (in response) the payment accounts are suspended from further use until the consumers associated with the payment accounts can be contacted. And, payment accounts experience high level threat events may be appended to high-risk segments where (in response) the payment accounts are terminated and reissued to the consumers. Further, it should be appreciated that different ones of the various countermeasures identified herein may be associated with different ones of the various risk segments (e.g., there may be multiple different low-risk segments with each one having one or more different countermeasures associated therewith; etc.). As an example, a potentially compromised EMV card may be assigned to a risk segment (e.g., a low-risk segment, etc.) based on the threat event involved, and then within the segment further assigned based on a desired countermeasure associated with the segment that blocks magnetic stripe, non-3D-Secure Internet, and mail order transactions (but still allows EMV and 3D-Secure internet transactions to continue).

Upon the payment account being appended to the appropriate risk segment, the engine 120 causes review of the payment account based on inclusion of the payment account in the segment (and based on the particular segment). This may include, for example, notifying the issuer 108 associated with the payment account that the payment account has been appended to a risk segment. In turn, the issuer 108 may then take further action to review the payment account, or to limit access to and/or usage of the payment account until the threat event is addressed and the payment account is reviewed (broadly, verified). In at least one embodiment, engine 120 may also (or alternatively) notify the payment network 106, and the payment network 106 may act to limit access to and/or usage of the payment account.

Following the review (and if the payment account is verified), the engine 120, the payment network 106, and/or the issuer 108 (or other entity) removes the payment account from the risk segment to which it was appended, whereby the engine 120, the payment network 106, and/or the issuer 108 (or other entity) returns access to and/or usage of the payment account to normal. However, if the payment account is not verified following the review, or is confirmed to be a fraud-accessed account, the engine 120 may preserve the payment account in the risk segment for further investigation, or remove it as instructed (e.g., if the payment account is closed, if the payment account is reissued, etc.).

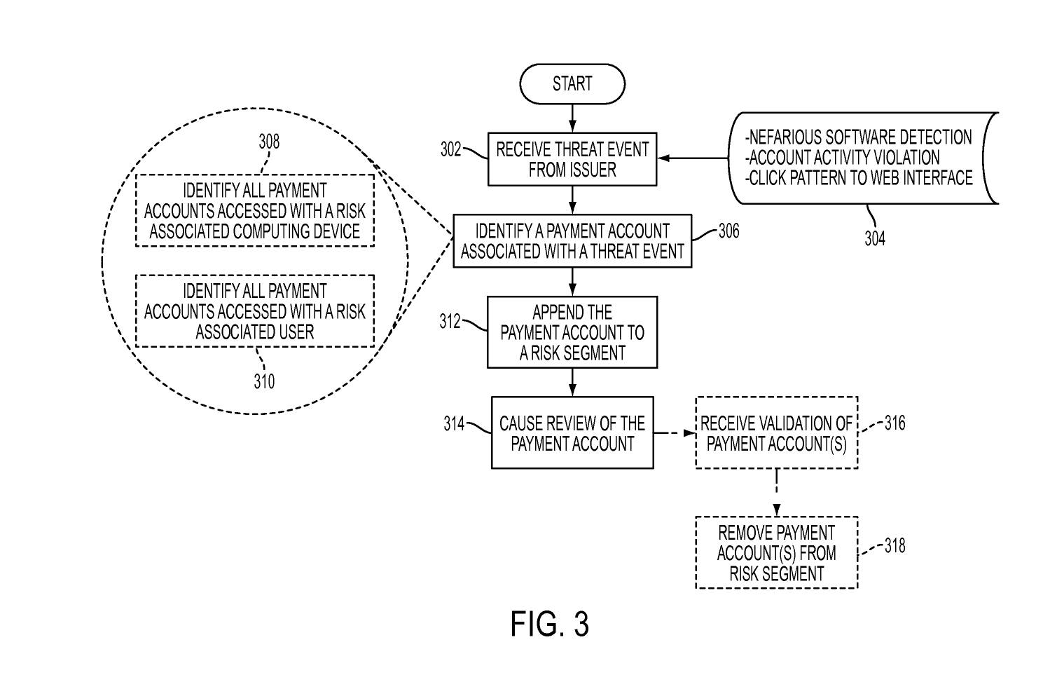

FIG. 3 illustrates an exemplary method 300 for use in identifying a payment account to a risk segment, for example, based on a threat event (or on multiple threat events). The exemplary method 300 is described as implemented in the engine 120 of the system 100, with additional reference to the payment network 106 and the issuer 108. Further, for purposes of illustration, the exemplary method 300 is described herein with reference to other parts of the system 100 and the computing device 200. As should be understood, however, the methods herein should not be understood to be limited to the exemplary system 100 or the exemplary computing device 200, and the systems and the computing devices herein should not be understood to be limited to the exemplary method 300.

In the exemplary method 300, when the issuer 108, for example, identifies a threat event (or potential threat event), the issuer 108, in this exemplary embodiment, transmits, via computing device 200, the threat event to the engine 120. The engine 120, in turn, receives the threat event, at 302. Example threat events received by the engine 120 are indicated, without limitation, at 304.

The issuer 108 employs a variety of mechanisms to detect improper, or unauthorized, access to computing devices 114 and 118. For example, the issuer 108 (or payment network 106) may provide to the user's computing device 118 multiple different anti-nefarious software tools, which are known to detect and, as necessary, quarantine and/or remove nefarious software upon detection. Upon detection of the nefarious software, the issuer 108 identifies, in providing the threat event to the engine 120, payment account information for all payment accounts potentially associated with the threat event, including, for example, those payment accounts accessed by the particular computing device 118, since the date of installation of the nefarious software on the computing device 118, or within one or more defined intervals of being accessed by the computing device 118 (e.g., within the last 2 days, within the last 7 days, within the last 15 days, etc.). If the defined interval is used, it may be defined by a user, for example, associated with the engine 120, to ensure, or at least attempt to ensure, that all payment accounts previously accessed by the affected computing device 118, since the nefarious software was installed, are identified. Upon detection of the nefarious software, however, regardless of the selected interval, the issuer 108 generates a nefarious software detection as the threat event, at 304. As described in more detail below, the identified payment accounts potentially affected by the nefarious software are then appended to appropriate risk segments.

The issuer 108 (or payment network 106) also provides standard procedures to user 116, and then monitors for departures from the standard procedures, i.e., account activity violations. In particular, the issuer 108 employs a variety of different standard procedures for the user 116, for example, to inhibit the user 116 from inadvertently, or intentionally, permitting a pattern of account activity, i.e., account activity violations, indicative of potential fraud. When the procedures are not followed, an account activity violation is generated by the issuer 108 as the threat event, at 304. For example, in attempt to gain unauthorized access to the consumer's payment account, a fraudster may contact user 116 of the issuer 108 and request a replacement payment device for the payment account be mailed to a new address, at which the fraudster would be able to collect the payment device for use. In such an example, by the time the consumer 112 is notified of the change of address to the payment account, or of the requested replacement device, the fraudster may already be performing unauthorized transactions. As such, the issuer 108 may prohibit (via a standard procedure) issuing of a replacement payment device within 10 days of a change of address on a payment account. Then, if the user 116 permits the replacement payment device to be ordered within 10 days of the change of address for the consumer's payment account, the issuer 108 generates a threat event, i.e., an account activity violation, and transmits it to the engine 120. In this example, the issuer 108 may not only transmit the consumer's payment account number to the engine 120, but also payment account numbers for all accounts accessed by the same user 116 within a defined interval (as just described). More generally, if the user 116, either inadvertently or intentionally, caused an account activity violation, other payment accounts access by the user 116 may have the same or different breaches of standard procedures and/or fraudulent purposes, each resulting in an account activity violation as a threat event generated by the issuer 108.

Further, the issuer 108 provides various web-based interfaces, in the form of an application installed at a smartphone, or websites accessible by a smartphone or tablet, etc. Regardless of type and/or format, each of the interfaces permits the consumer 112, at computing device 114, to access the consumer's payment account to perform a variety of tasks (e.g., check account balances, access bill pay features, transfer funds, dispute changes, spend rewards, change account information, order replacement payment devices, etc.). Each interface includes at least one link, or multiple links, which are generally organized in a sequence. As part of providing the interfaces, the issuer 108 may also monitor them for certain click patterns, which are indicative of, for example, an automated entity interacting with the interfaces, etc. In one example, a click pattern includes an ordered click-through at an interface, i.e., clicking links included in the interface in sequence, etc. When the issuer 108 detects that such a click pattern at the interface has gained access to a payment account, from the consumer's computing device 114, the issuer 108 generates a click pattern notification as the threat event, at 304.

Moreover, although not shown in method 300, the issuer 108 may take specific action to identify a transaction to a payment account to be an abnormal transaction, potentially, depending on the particular type of payment account, particular type of transaction, and/or other criteria as described above (e.g., use of a prepaid travel card at an appliance merchant, etc.). Upon identification of the abnormal transaction, the issuer 108 generates an abnormal transaction notification as a threat event, for example, at 304 in method 300, etc.

It should be appreciated that other threat events may be generated in the method 300 (e.g., at 304, etc.), as appropriate (e.g., by the issuer 108, by another part of the system 100, etc.), for example, based on other contacts by risk associated computing devices and/or other contacts by risk associated users and/or other actions, etc., and transmitted to the engine 120. For example, a transaction processing part of the acquirer 104 or the payment network 106 may detect a pattern, or account activity violation, or nefarious software, and, as a result, may generate and transmit (at 304) a threat event to the engine 120. Or, the issuer 108 may detect that a consumer's payment device is being used at a merchant location that is a long distance away from a current location of the consumer 112 (e.g., based on location data for a smart phone associated with the consumer 112, etc.) and, as a result, may generate and transmit (at 304) a threat event to the engine 120. Or, the issuer 108 may detect that a consumer's payment device is being used at a merchant location that is in a different country from the consumer's place of residence and, as a result, may generate and transmit (at 304) a threat event to the engine 120. Furthermore, it is contemplated that the consumer 112, via the computing device 114 or in another manner, or even the acquirer 104 or the merchant 102 (or other entity), may detect a threat event (at 304) and report the threat event to the engine 120.

With continued reference to FIG. 3, upon receiving the threat event, or multiple threat events, the engine 120 identifies the payment account associated with the threat, at 306. When the threat event is received from the issuer 108, as in the illustrated method 300, the issuer 108 typically also provides the payment account number to the engine 120, whereby identifying the payment account includes merely identifying the payment account number from the notification received from issuer 108. In various implementations, however, additional operations may be involved depending, for example, on the form and/or content of information provided by the issuer 108 with the threat event. Further, when the threat event is received by the engine 120 from other entities, other than the issuer 108, the threat event may or may not include/identify the payment account number, or alternatively, some indicia of the payment account with which the engine 120 is able to identify the payment account and corresponding payment account number (e.g., via subsequent communication with the payment network 106, the issuer 108, etc.; via a transaction data warehouse; etc.).

In any case, in connection with identifying the payment account, at 306, the engine 120 may optionally (as indicated by the dotted lines n FIG. 3) identify all payment accounts accessed by a risk associated computing device, at 308. For example, as described above, when nefarious software is detected at one of the computing devices 118, the issuer 108 may include, with the threat event, a listing of all payment accounts accessed by the computing device 118 (i.e., a risk associated computing device) (e.g., within a predefined time period or not, etc.), which are then identified by the engine 120, at 308. Similarly, the engine 120 may optionally (again as indicated by the dotted lines in FIG. 3) identify all payment accounts accessed by a risk associated user, at 310. For example, as also described above, when an account activity violation is detected, the issuer 108 may include, with the threat event, a listing of all payment accounts accessed by the user 116 (i.e., a risk associated user) (e.g., within a predefined time period or not, etc.), which are then identified by the engine 120, at 310. Or, the engine 120 may simply access a listing of potentially affected payment accounts from a transaction data warehouse, as needed.

Then, at 312, the engine 120 appends the identified payment account to a risk segment. This may include appending the payment account to one risk segment or to multiple risk segments, as appropriate, for example, segmented based on a type of the threat event, a degree of the threat associated with the event, a class of the payment account, or other suitable factors associated with the threat event and/or the payment account, etc. Appending the payment account to the risk segment may further include appending multiple payment accounts, for example, as identified, at 308 and 310, to one or more of the same or different risk segments. For example, as described above, when the threat event is associated with contact with multiple payment accounts by a risk associated computing device, all payment accounts (or at least a portion of the payment accounts) are identified, at 306, and then appended to the appropriate risk segments, at 312.

In various embodiments, the engine 120 may employ one or more further conditions prior to appending the payment accounts to the risk segments, at 312. For example, the engine 120 may utilize a bulk load of reported impacted payment accounts (e.g., via a transaction data warehouse, etc.), assignments from consumer reports (e.g., based on communications from the issuer 108 to the consumer 112 related to suspicious transactions and confirmations from the consumer 112 that the suspicious transactions are indeed fraudulent, etc.), etc. to help identify payment accounts to be appended to risk segments. Further, it is contemplated that the engine 120 may employ Bayesian statistics (and corresponding models), as are generally known, to help learn which events and/or transactions are valid and which are fraudulent (or are threats), and thereby help identify (e.g., automatically, etc.) payment accounts to be appended to risk segments.

With continued reference to FIG. 3, once the payment account is appended to the risk segment, the engine 120 causes a review of the payment account, at 314. The review (e.g., investigation, verification, etc.) is conducted, in this embodiment, by the issuer 108 (but could be conducted by the payment network 106 or by another suitable entity in other embodiments). The engine 120 further, as part of causing the review, may suspend (or communicate with the issuer 108 to suspend) the payment account associated with the threat event. Or, the issuer 108 may simply suspend the payment account associated with the threat event upon becoming aware of the payment account being appended to the risk segment. For example, the engine 120 may flag the payment account to the issuer 108 (or potentially to the payment network 106), and the issuer 108 may intercept and decline any further attempted authorization for the payment account.

In some implementations, when the review is conducted apart from the issuer 108 (at least in part), the engine 120, as part of causing the review, may notify other entities in the system 100 such as the payment network 106 or other entity of the addition of the payment account to the risk segment. In such implementations, the notification is generally provided, from the engine 120, when the payment account is appended to the risk segment. The notification may further be resent, at various intervals (regular or irregular) as long as the payment account remains in the risk segment. In such cases, upon receiving the notification from the engine 120, the issuer 108, for example, may review the payment account to determine if unauthorized access has occurred. The review may be more rigorous depending on the type of threat event, based on which the payment account is appended to the risk segment (and/or based on the particular risk segment to which the payment account is appended). For example, an ordered click-through, at the consumer's computing device 114, may be a strong indication of unauthorized access and require more rigorous review, while a contact by the user 116, who caused an account activity violation in a different payment account, may require less rigorous review.

In addition to the review of the payment account, at 314, the issuer 108 (or the engine 120) may institute a variety of changes to rules permitting access to the payment account. In one example, when an ordered click-through at an issuer application precipitated the threat event, the issuer 108 (or the engine 120) may suspend or lock-out the application for the payment account. Additionally, or alternatively, the issuer 108 (or engine 120) may further alter rules associated with usage of the payment account, including, without limitation, approval or decline of a transaction. For example, the issuer 108 may change the limits associated with the payment account, or alter one or more scripts (or operations) of EMV payment devices. The issuer 108 (or the engine 120) may further create a fraud case or an account takeover case, based on the assignment of the payment account to the risk segment (or to a particular risk segment), providing for the specific review of the payment account, with each case having specific rules and/or operations to prevent unauthorized access to and/or usage of the payment account, or even measures to identify the unauthorized user. As another example, the issuer 108 (or the engine 120) may alter an interactive voice response system associated with the issuer 108 and accessible by the consumer 112 to access and/or use the payment account.

In the method 300, the engine 120 operates generally in real time, or near real time, to append the payment account to the risk segment and further cause the review, in response to corresponding the threat event. In this manner, the engine 120 permits the payment account to be reviewed, and any limitations imposed on access to and/or usage of the payment account to be effected, before an unauthorized user is permitted, in some instances, to utilize the unauthorized access and/or usage, or soon thereafter. As such, access to and/or usage of the payment account, after a threat event is provided, is often limited. For example, the engine 120 is operable to process a real time stream of transactions (and corresponding transaction data), account updates, web activity, fraud case activity, location updates, etc. and mine the data based on various factors. Such factors may include, without limitation, a configuration of the data, a relation of the data to historical data, a relation of the data to models and rules, or any other factors that may be used to create a set of actionable events to trigger rules or models based on segment assignments or trigger optional alerts to the issuer 108 (or others) for additional analysis or actions.

Finally, when the review by the issuer 108 (or the payment network 106) is completed, either with a determination that the payment account may return to normal access and/or usage or that further steps (e.g., cancellation, etc.) are to be employed, the engine 120 may optionally (as indicated by the dotted lines in FIG. 3) receive, at 316, a verification from the issuer 108 that the payment account is being handled accordingly. In response to the verification, the engine 120 may optionally (as again indicated by the dotted lines) remove, at 318, the payment account from the risk segment. In doing so, any restrictions and/or alterations made by the engine 120, in response to appending the payment account to the risk segment, may be undone. In one or more embodiments, however, the verification from the issuer 108 may permit the engine 120 to remove the payment account from the risk segment, but may include instructions for the engine 120 to preserve one or more of the restrictions and/or alterations for a period of time, or indefinitely (even though the payment account is removed from the risk segment), until further verification from the issuer 108. In some implementations, it is contemplated that the payment account may remain appended to the risk segment for a predefined period after which it is then removed, if not otherwise acted on (or if the period is not extended) by a user associated with the engine 120 or the issuer 108 (either independent of any verification from the issuer 108 or in combination therewith).

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

Further, based on the foregoing specification, the above-described embodiments of the disclosure may be implemented using computer programming or engineering techniques including computer software, firmware, hardware or any combination or subset thereof, wherein the technical effect may be achieved by performing at least one of: (a) identifying a payment account associated with a threat event where the threat event includes a contact by a risk associated computing device accessing the payment account, or a contact by a risk associated user accessing the payment account; (b) appending the payment account to a risk segment; (c) causing review of the payment account, based on inclusion of the payment account in said risk segment; (d) identifying each payment account accessed by said computing device within a defined interval; (e) identifying each payment account accessed by said risk associated user within a defined interval; (f) receiving, from an issuer associated with the payment account, the threat event; (g) notifying an issuer of the payment account indicating the payment account is appended to the risk segment, whereby the issuer is able to act to limit access to and/or usage of the payment account; and (h) suspending usage of the payment account, thereby causing a further transaction to the payment account to be declined, or monitoring subsequent transactions to the payment account.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “connected to,” “in communication with,” or “coupled to” another element, it may be directly on, connected or coupled to, or in communication with the other element, or intervening elements may be present. In contrast, when an element is referred to as being “directly on,” “directly connected to,” “directly in communication with,” or “directly coupled to” another element, there may be no intervening elements present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the exemplary embodiments.

What is claimed is:

1. A computer-implemented method for use in identifying payment accounts to segments, the method comprising:
identifying, by a computing device, a payment account associated with a threat event, the threat event including a contact by a risk associated computing device accessing the payment account or a contact by a risk associated user accessing the payment account;
appending, by the computing device, the payment account to a risk segment, the risk segment including a risk level and at least one countermeasure for responding to the threat event, the risk level and the countermeasure used together as a basis for appending the identified payment account to the risk segment; and
causing review of the payment account, based on inclusion of the payment account in said risk segment.

2. The computer-implemented method of claim 1, wherein the contact by the risk associated computing device includes detection of nefarious software on said computing device;
wherein identifying the payment account includes identifying each payment account accessed by said computing device within a defined interval; and
wherein appending the payment account to the risk segment includes appending each identified payment account to the risk segment.

3. The computer-implemented method of claim 1, wherein the contact by a risk associated user includes identification of an account activity violation;
wherein identifying the payment account includes identifying each payment account accessed by said risk associated user within a defined interval; and
wherein appending the payment account to the risk segment includes appending each identified payment account to the risk segment.

4. The computer-implemented method of claim 3, wherein the account activity violation includes a sequence of activities, which includes a change of address request for the payment account, a request for a replacement payment device within a predefined interval of the change of address request, and the request for the replacement payment device being permitted.

5. The computer-implemented method of claim 1, wherein the contact by the risk associated computing device includes detection of a click pattern at a web interface accessing the payment account, via said computing device; and
wherein the click pattern includes an ordered click-through.

6. The computer-implemented method of claim 1, further comprising receiving, from an issuer associated with the payment account, the threat event.

7. The computer-implemented method of claim 1, wherein causing review of the payment account includes notifying an issuer of the payment account that the payment account is appended to the risk segment, whereby the issuer is able to act to limit access to and/or usage of the payment account.

8. The computer-implemented method of claim 1, wherein causing review of the payment account includes suspending usage of the payment account, thereby causing a further transaction to the payment account to be declined.

9. One or more non-transitory computer readable storage media having computer-executable instructions embodied thereon that, when executed by at least one processor, cause the at least one processor to:
receive a threat event associated with a payment account, the threat event including a contact by a risk associated computing device accessing the payment account or a contact by a risk associated user accessing the payment account;
identify the payment account associated with the threat event;
append the payment account to a risk segment; and
cause a review of the payment account.

10. The one or more non-transitory computer readable storage media of claim 9, wherein the risk segment is one of multiple risk segments;
wherein when executed by the at least one processor, the computer-executable instructions cause the at least one processor, in order to identify the payment account, to identify each payment account accessed by the risk associated computing device and/or the risk associated user within a predefined interval; and
wherein when executed by the at least one processor, the computer-executable instructions cause the at least one processor to append each identified payment account to one of the multiple risk segments.

11. The one or more non-transitory computer readable storage media of claim 9, wherein when executed by the at least one processor, the computer-executable instructions further cause the at least one processor to cause rules associated with approval and/or decline of a transaction to the payment account to be altered.

12. The one or more non-transitory computer readable storage media of claim 9, wherein when executed by the at least one processor, the computer-executable instructions cause the at least one processor, in order to append the payment account to the risk segment, to append the payment account to the risk segment, and not a different risk segment, based on the threat event.

13. The one or more non-transitory computer readable storage media of claim 9, wherein the risk associated computing device is part of an acquirer; and
wherein when executed by the at least one processor, the computer-executable instructions further cause the at least one processor to receive the threat event from said acquirer.

14. A risk segmenting computing device comprising: at least one processor; and a memory in communication with the at least one processor and storing instructions configured to instruct the at least one processor to:
receive a threat event for a payment account from an issuer, the threat event including a contact by a risk associated computing device accessing the payment account, a contact by a risk associated user accessing the payment account, or an abnormal transaction to the payment account;
identify each payment account associated with the threat event;
append the identified payment account(s) to at least one of multiple risk segments stored in the memory; and
notify the issuer of each appended payment account that the payment account is appended to the at least one risk segment.

15. The risk segmenting computing device of claim 14, wherein when the contact by the risk associated computing device includes detection of nefarious software on said computing device, the instructions are configured to instruct the at least one processor, in order to identify each payment accounts, to identify each payment account access by said computing device within a defined interval.

16. The risk segmenting computing device of claim 15, wherein when the contact by a risk associated user includes identification of an account activity violation, the instructions are configured to instruct the at least one processor, in order to identify each payment account, to identify each payment account accessed by said risk associated user within a defined interval.

17. The risk segmenting computing device of claim 16, wherein the account activity violation includes a sequence of activities, which includes a change of address request for the payment account, a request for a replacement payment device within a predefined interval of the change of address request, and the request for the replacement payment device being permitted.

18. The risk segmenting computing device of claim 14, wherein the instructions are configured to further instruct the at least one processor to suspend the identified payment account(s).

19. The risk segmenting computing device of claim 14, wherein the contact by the risk associated computing device includes detection of a click pattern at a web interface accessing the payment account, via said computing device; and
wherein the click pattern includes an ordered click-through or a temporal based click-through.

20. The risk segmenting computing device of claim 19, wherein the multiple risk segments each include a risk level and a countermeasure that are used together by the at least one processor as a basis for appending the identified payment account(s) to the at least one of the multiple risk segments.
